(19) United States
(12) Patent Application Publication
(10) Pub. No.: US 2012/0144872 A1
(43) Pub. Date: Jun. 14, 2012

(54) APPARATUS AND METHOD FOR AUTOMATIC SELF-WASHING

(76) Inventors: Jerrod Aaron Kappler, Louisville, KY (US); Christopher Hoppe, Louisville, KY (US); James Rulon Young Rawson, Clifton Park, NY (US); David Gilles Gascoyne, Niskayuna, NY (US); John Ouseph, Prospect, KY (US)

(21) Appl. No.: 12/967,590

(22) Filed: Dec. 14, 2010

(51) Int. Cl. D06F 33/00; B08B 7/04

(52) U.S. Cl. 68/12.02; 134/18

(57) ABSTRACT

An apparatus and techniques for automatic self-washing of a clothes washing machine are provided. The clothes washing machine includes one or more storage tanks, and a user interface, wherein the user interface enables a user to schedule an automatic recurring self-cleaning wash cycle. The techniques include enabling the washing machine to automatically run the self-cleaning wash cycle according to schedule, wherein enabling the washing machine to automatically run the self-cleaning wash cycle comprises automatically dispensing an amount of self-cleaning additive from one of the one or more storage tanks into the cycle.

### BACKGROUND OF THE INVENTION

The subject matter disclosed herein relates to appliances such as washing machines, and more particularly to cleaning cycles and the like.

With washers, especially front-load washers, an issue can exist with respect to the washing machine developing an odor over time. If, for instance, you wash a set of clothes, the tub (which holds the water for the basket and acts as a strainer for the clothes, and is generally a part of the machine that a user cannot see) and the back of the basket include dark and wet areas that can develop odors (for example, as a result of an accumulation of fats used in the detergent chemistry that stick to surfaces). Consequently, existing approaches to remedy this issue include the creation of basket cleaner/washer cleaner cycles. These are special cycles on front-load and top-load washers that use bleach or a solid chemical and a large amount of water, and the cycle generates mechanical action with the water to attempt to knock the accumulated material off the basket and the tub. Such approaches, however, are manual processes and involve significant and repeated action on the part of the user.

### BRIEF DESCRIPTION OF THE INVENTION

As described herein, the example embodiments of the present invention overcome one or more disadvantages known in the art.

One aspect of the present invention relates to a method of operating a washing machine. The washing machine includes one or more storage tanks and a user interface wherein the user interface enables a user to schedule an automatic recurring self-cleaning wash cycle. The method includes enabling the washing machine to automatically run the self-cleaning wash cycle according to schedule, wherein enabling the washing machine to automatically run the self-cleaning wash cycle comprises automatically dispensing an amount of self-cleaning additive from one of the one or more storage tanks into the cycle.

Another aspect relates to an apparatus comprising: a clothes basket rotatable about an axis; a motor coupled to the clothes basket; one or more storage tanks; one or more conveyance mechanisms between the each of the one or more storage tanks and a washing chamber; a user interface; a sensor; and a processor coupled to the motor, the one or more conveyance mechanisms, the user interface, and the sensor. The processor is operative to carry out one or more of the aforementioned methods.

One or more embodiments of the invention or elements thereof can be implemented in the form of a computer product including a tangible computer readable storage medium with computer useable program code for performing the method steps indicated.

These and other aspects and advantages of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. Moreover, the drawings are not necessarily drawn to scale and, unless otherwise indicated, they are merely intended to conceptually illustrate the structures and procedures described herein.

### BRIEF DESCRIPTION OF THE DRAWINGS

In the drawings:

FIG. 1 is a block diagram of an example system, in accordance with a non-limiting example embodiment of the invention;

FIG. 2 is a pictorial view of an example top-loading washing machine;

FIG. 3 is a cross-sectional side elevation of an example top-loading washing machine similar to that depicted in FIG. 2;

FIG. 4 is a semi-schematic rear elevation of an example front-loading washing machine;

FIG. 5 is a semi-schematic cross-sectional side elevation taken along line VIII-VIII of FIG. 4;

FIG. 6 presents an example washer, in accordance with a non-limiting example embodiment of the invention;

FIG. 7 presents a washer with bulk laundry additive dispensing capability, in accordance with a non-limiting example embodiment of the invention;

FIG. 8 presents a washer with bulk laundry additive dispensing and bulk self cleaning additive dispensing capability, in accordance with a non-limiting example embodiment of the invention;

FIG. 9 presents a self cleaning washing machine user interface, in accordance with a non-limiting example embodiment of the invention;

FIG. 10 presents self cleaning washing machine self cleaning flow chart, in accordance with a non-limiting example embodiment of the invention;

FIG. 11 is a flow chart of a method for automatically running a recurring self-cleaning wash cycle, in accordance with a non-limiting example embodiment of the invention; and

FIG. 12 is a block diagram of an example computer system useful in connection with one or more embodiments of the invention.

### DETAILED DESCRIPTION OF THE EXEMPLARY EMBODIMENTS OF THE INVENTION

One or more embodiments of the invention provide a method and/or apparatus for automatic self-washing.

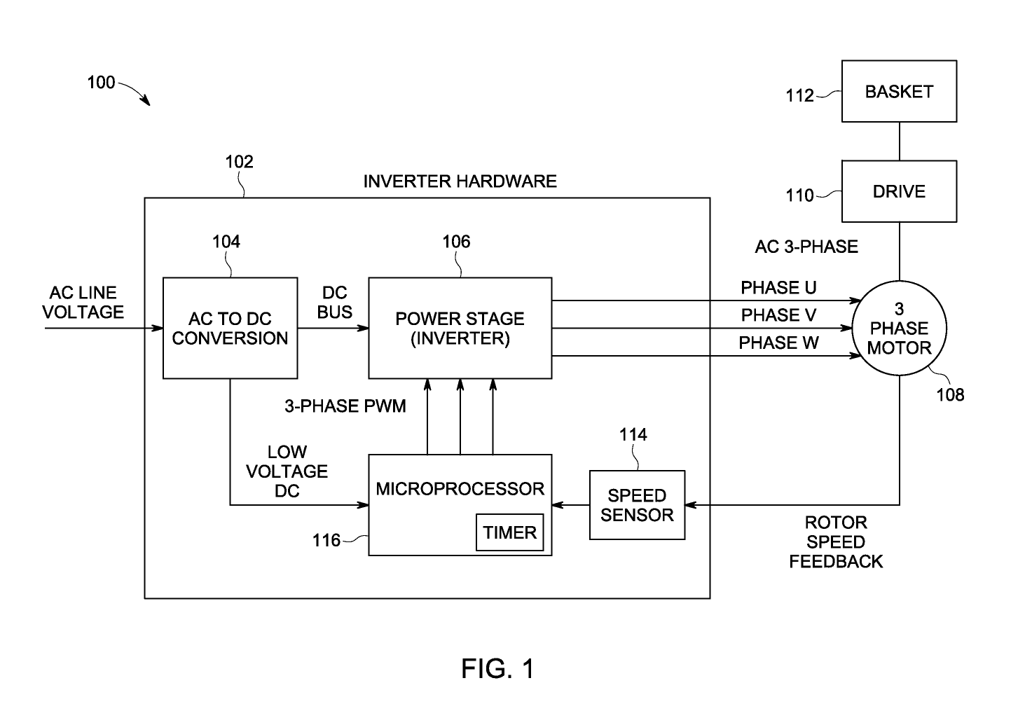

Reference should now be had to block diagram 100 of FIG. 1. AC line voltage is supplied to inverter hardware 102. The AC is converted to DC in block 104 using a rectifier or the like. Relatively high voltage DC is provided to a DC power bus and then to inverter 106 to provide 3-phase AC to 3-phase motor 108. Relatively low voltage DC is provided to microprocessor 116 which can include a suitable timer (not separately numbered). Motor 108 is coupled to basket 112 for receiving clothes to be washed, with a suitable drive 110. While in theory there could be a direct coupling, in practice, a suitable reduction arrangement is preferably employed, such as a pulley and belt arrangement, gearing, or the like, wherein basket 112 turns at a lower RPM than motor 108. In a specific non-limiting example, the reduction is about 13.2 such that the RPM of basket 112 must be multiplied by 13.2 to obtain the motor shaft speed. Unless otherwise noted, the RPM values given herein are for the basket 112. A suitable sensor 114 is employed to provide feedback regarding the basket RPM value (or motor RPM value, since the relationship between the two is known based on the reduction of drive 110) to microprocessor 116. Microprocessor 116 is programmed, for example, with suitable software or firmware, to implement one or more techniques as described herein. In other embodiments, an ASIC or other arrangement could be employed.

The skilled artisan will be familiar with conventional washer systems and given the teachings herein will be enabled to make and use one or more embodiments of the invention; for example, by programming a microprocessor 116 with suitable software or firmware.

As used herein, a clothes washer refers to a system with a rotating clothes container. The axis of rotation of the clothes container may be vertical (e.g., top load), substantially horizontal (e.g., front load), or may even have an intermediate value. Typically, the system will include washing and spinning cycles, but one or more embodiments are applicable to systems with only a spin cycle; e.g., an extraction machine. As noted, the rotational speed (angular velocity) of the basket (clothes container) 112 and/or the motor 108 is a significant parameter. It may be specified in RPM, radians per second, and so on.

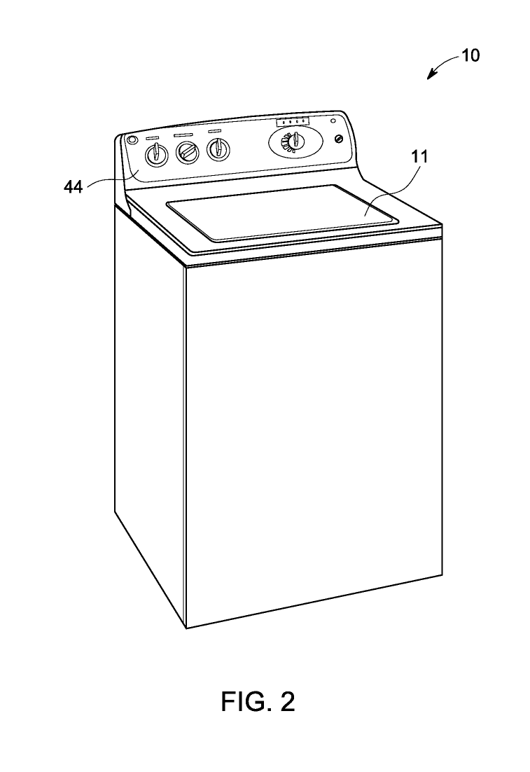

FIG. 2 shows an example top-loading washing machine 10 including a control panel or portion 44 and a loading door 11. Machine 10 is a non-limiting example of a machine with which one or more aspects of the invention may be implemented.

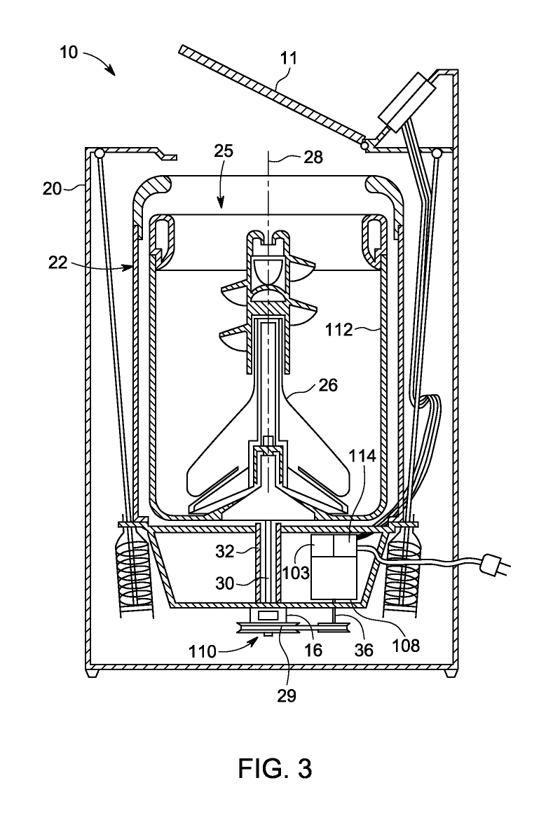

FIG. 3 shows a cross-sectional side elevation of an example top-loading washing machine 10 similar to that depicted in FIG. 2. Clothes are loaded through door 11 into clothes-receiving opening 25. The machine has an external cabinet 20. A structure 22 is suspended with springs (not separately numbered) and includes basket 112 and agitator 26 revolving about axis 28. The basket 112 is driven by motor 108 via drive arrangement 110; in this case, the latter includes a pulley mounted to motor drive shaft 36 connected by belt 29 to a pulley mechanically linked to basket driveshaft 30 and spin tube 32, which are concentric shafts. Driveshaft 30 is directly coupled to the pulley and belt 29, and drives the agitator. Spin tube 32 is directly coupled to the basket 112. A clutch locks elements 30 and 32 together during spin. Speed sensor 114 is provided on motor driveshaft 36. Motor 108 is controlled by a control unit 103 which may include components such as 104, 106, and 116. As would be appreciated by one skilled in the art, FIG. 3 serves merely as an example, and, as such, additional and/or separate embodiments can be implemented in connection with the invention (such as, for example, the use of an impeller, a direct drive motor, etc.). Additionally, one or more embodiments of the invention can be implemented with additional types of motors such as, a permanent magnet, a direct drive motor, or any motor driven by an inverter.

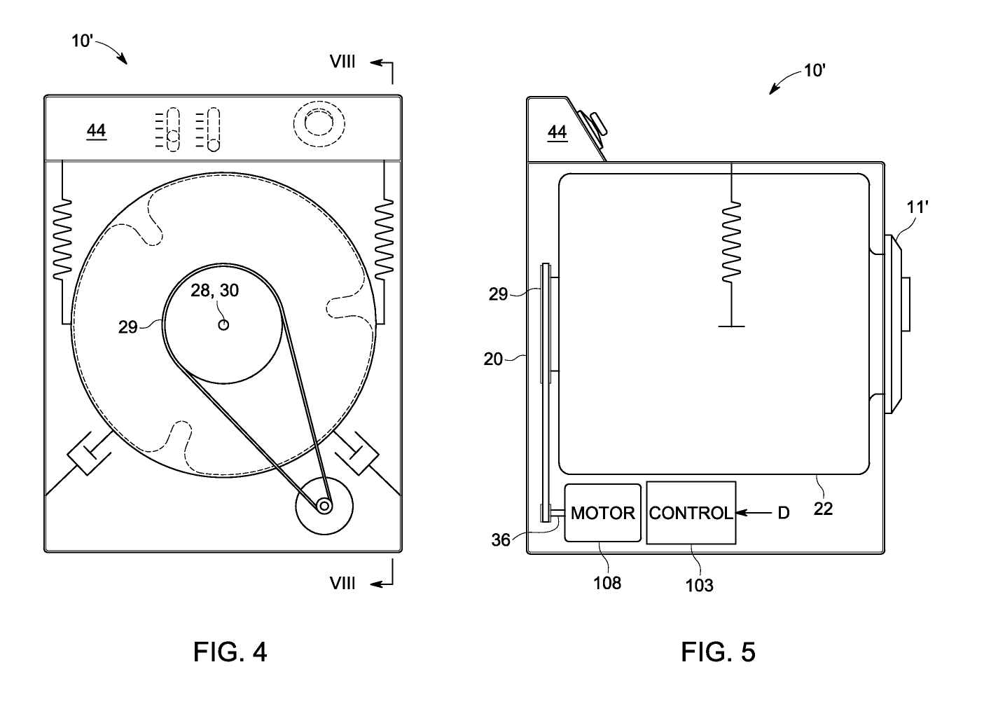

FIG. 4 is a semi-schematic rear elevation of an example front-loading washing machine 10′ and FIG. 5 is a semi-schematic cross-sectional side elevation taken along line VIII-VIII of FIG. 4. Machine 10′ is another non-limiting example of a machine with which one or more aspects of the invention may be implemented. Clothes are loaded through door 11′. The machine has an external cabinet 20 and a control panel or portion 44. A structure 22 is suspended with springs and dampers (not separately numbered) and may include a basket and agitator revolving about axis 28. The basket is driven by motor 108 via a drive arrangement; in this case, the latter includes a pulley mounted to motor drive shaft 36 connected to a pulley mounted to basket driveshaft 30 by belt 29. A speed sensor can be provided. Motor 108 is controlled by a control unit 103 which may include components such as 104, 106, and 116.

One or more embodiments can be implemented in the software or firmware that controls microprocessor 116 and drives the motor 108 for the washing machine.

As described herein, one or more embodiments of the invention include techniques and apparatuses for an automatic self-wash system.

One or more embodiments of the invention include using a smart dispense system, which utilizes one or more tanks that can hold multiple cycles' worth of washer additive (for example, detergent, fabric softener, etc.). Accordingly, when a user runs the machine, the user will only periodically (for example, every 3-6 months) need to put in more additive. Additionally, in one or more embodiments of the invention, the washing machine can dispense the additive based on characteristics such as, for example, how dirty the clothes are, the size of the load, etc. As such, one or more embodiments of the invention include storing liquid in a bulk quantity, and dispensing portions of the liquid based on certain characteristics of the load that the machine senses.

Further, one or more embodiments of the invention include using a different chemical (for example, bleach, or specific liquid chemicals for cleaning the washing machine), storing that chemical, and setting up the machine controls to make use of a calendar function (in conjunction with, for example, a user interface, LCD screen, touch-screen, etc. on the machine) to schedule an automatic recurring washer-clean cycle (for a specific time/day/recurrence to have the machine clean itself). Accordingly, a user has the benefit of being able to schedule the washer-clean cycles for times that do not coincide or interfere with normal wash times. Additionally, users do not have to manually set up and run each self-wash/self-clean cycle in connection with one or more embodiments of the invention.

Accordingly, as detailed herein, one or more embodiments of the invention include providing a washing machine with the capability to clean itself automatically, and on a repeated basis. The washer can include one or more internal tanks to store a washing machine cleaning agent (for example, a liquid agent). A pump can be used to convey the cleaning agent to the washing compartment. Also, as described herein, a control board is programmable by the user to set the date and time of cleaning. Thus, the washer can run a specialized machine cleaning cycle on a schedule, set up by the user, on a repeated basis.

Also, one or more embodiments of the invention include enabling the setting up of an automatic cycle that runs a washer self-cleaning cycle with the ability to automatically dispense the correct amount of cleaning agent from a storage tank inside the machine. Accordingly, an example embodiment of the invention can include a front-loading washing machine with a self cleaning cycle and bleach dispenser (or dispenser for other disinfecting cleaning agent) for automatic addition of bleach/disinfecting agent to the washing basin during the self cleaning cycle. A bleach dispenser (or disinfecting cleaning agent dispenser) will allow the controlled addition of bleach/disinfecting agent to the washing drum of a washing machine (for example, a front-loading washing machine) during a self-cleaning cycle.

In one or more embodiments of the invention, a separate and/or additional tank would be implemented in a washing machine to hold the additive/bleach/washer self-cleaning agent (separate and/or additional from the tank(s) holding detergent, fabric softener, etc.) as well as a separate and/or additional fluid conveyance system within the machine to move the fluid from the tank to the wash chamber.

Also, unlike existing systems that allow a user to schedule automatic clothes washing cycles, one or more embodiments of the invention enable a user to schedule and run separate wash cycles after a recurring self-wash cycle has been scheduled and/or programmed into the machine. In other words, in existing systems, if a user set a delayed start cycle, and if the user subsequently came back to the machine before that cycle began and decided that he or she did not want to wait to run that cycle but rather wanted to run a separate cycle right now, then the user would have to erase the settings previously input into the machine, make new settings and begin again. For example, if a user wanted to run a self-clean cycle on a washing machine, he or she could put into the machine a fresh cleaning tablet, let it sit in the basket, and possibly set the machine for a delayed start. However, in existing approaches, the thing that the user cannot do is run a different cycle. If the user wanted to run a clothes load, then he or she would have to erase the basket self-clean cycle that was previously set up, take the fresh tablet back out, put the clothes in and run the new cycle to clean the clothes, and then afterwards, re-set the system back up to go into the basket clean cycle. With one or more embodiments of the invention, however, a user can set up a recurring delay start (for self-cleaning) and still be able to run other cycles in between the self-cleaning cycles without affecting the cycle set up for the basket clean operation.

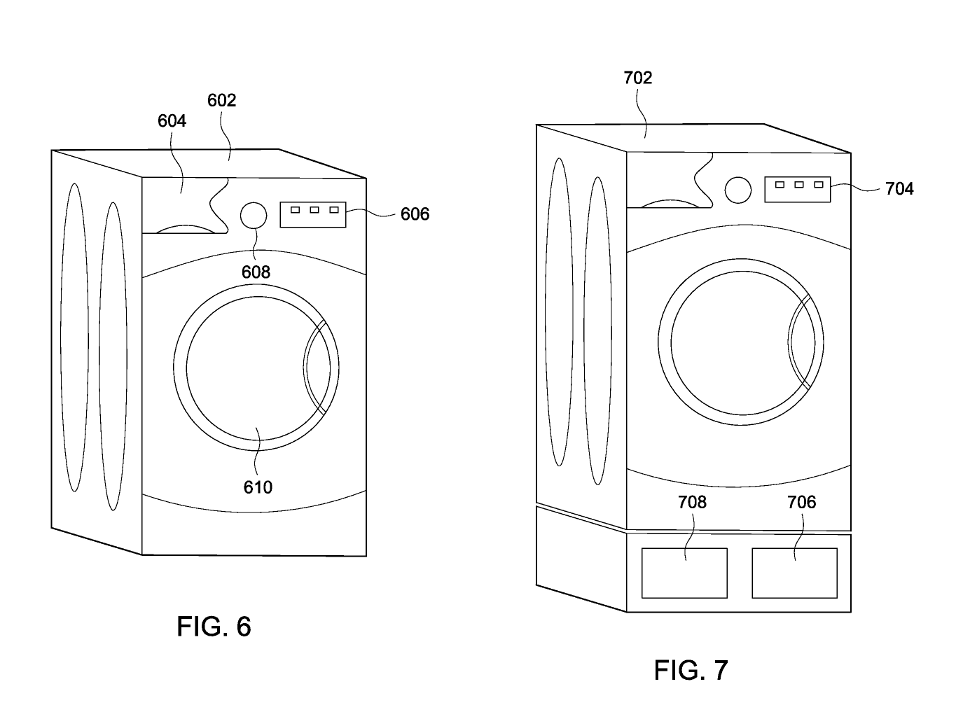

FIG. 6 presents an example washer, in accordance with a non-limiting example embodiment of the invention. By way of illustration, FIG. 6 depicts a washer 602, which includes a manual dispenser (for an additive) 604, a controller/user interface 606, a cycle knob 608 and a door (for access to the clothes basket) 610.

FIG. 7 presents a washer with bulk laundry additive dispensing capability, in accordance with a non-limiting example embodiment of the invention. FIG. 7 depicts a washer that has automatic laundry additive dispensing capability. By way of illustration, FIG. 7 depicts a washer 702, which includes a controller/user interface 704, and bulk laundry additive storage tanks 706 and 708.

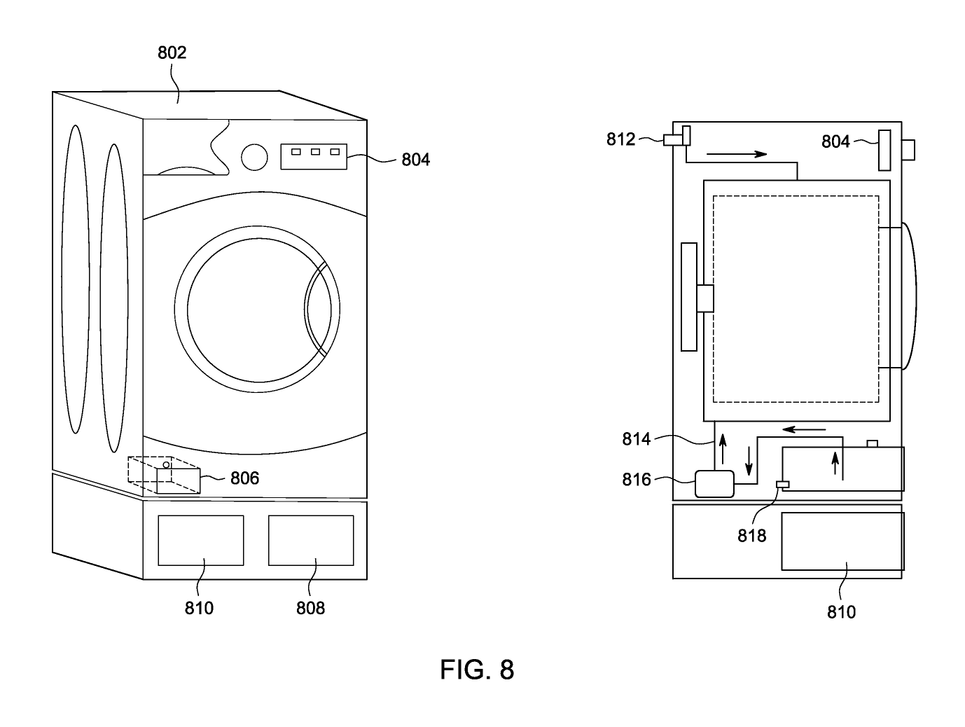

FIG. 8 presents a washer with bulk laundry additive dispensing and bulk self cleaning additive dispensing capability, in accordance with a non-limiting example embodiment of the invention. FIG. 8 depicts a washer that has the added capability of a washer cleaner additive storage tank and the ability to program the control to setup an automatically recurring schedule for cleaning the washer. By way of illustration, FIG. 8 depicts a washer 802, which includes a controller/user interface 804, and bulk laundry additive storage tanks 806, 808 and 810. Additionally, each additive storage tank would include its own conveyance system for transferring liquid into the basket/wash chamber.

The conveyance system can include a set of hoses (such as, for example, 814) that contain the cleaning agent while moving from the storage tank to the wash chamber. Movement of the fluid is forced by use of a pump 816 mounted in the washing machine. As an example, a peristaltic pump can be used to provide a suction force to move the fluid out of the storage tank and then push the fluid into the wash chamber.

A suction hose or line can be assembled to the storage tank and sufficiently placed as to remove all of the fluid in the storage tank over the course of a multitude of wash cycles. The suction tube would then be connected through a peristaltic pump or other type of pump. The fluid line would then leave the pump and be connected to a port on the wash chamber allowing the fluid to enter the wash chamber and be mixed with the wash water (for example, from water inlet 812). The pump would be in electrical communication with the controller of the washing machine.

In addition, the storage tank can be equipped with a liquid level sensor 818 in communication with the controller that would indicate when the fluid level was low. This would serve to warn the user of the washing machine that additional cleaning agent would need to be placed into the fluid storage tank.

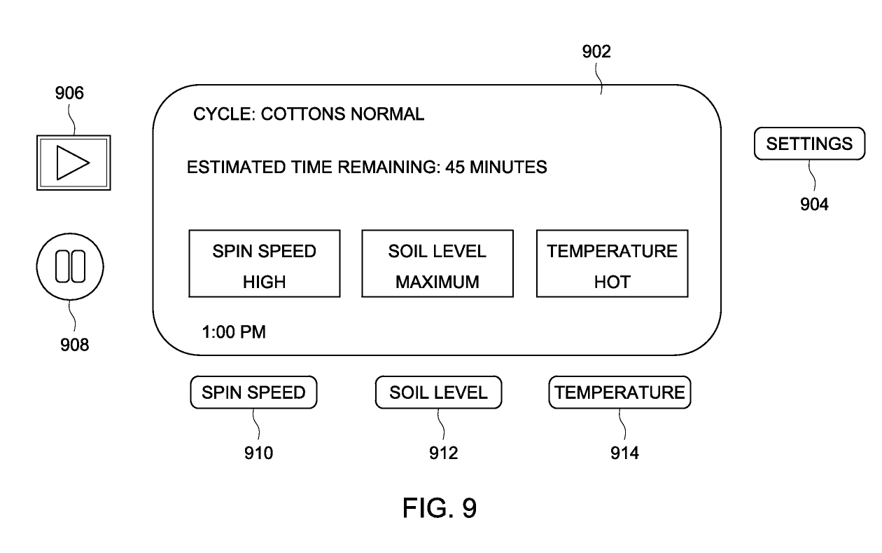

FIG. 9 presents a self cleaning washing machine user interface, in accordance with a non-limiting example embodiment of the invention. By way of illustration, FIG. 9 depicts a display 902, as well as button/selection options such as settings 904, start 906, pause 908, spin speed 910, soil level 912 and temperature 914.

The user interface of one or more embodiments can depend on how calendar functionality is arranged. User interfaces in some embodiments can include touch-screens, while others can include knobs and/or buttons on the side of a screen/display. In one or more embodiments of the invention, a user can scroll through the options on the interface (for example, either by swiping finger across touch-screen or turning a knob to scroll through options) to select a self-clean cycle, which can bring up a separate screen to set-up, for example, frequency, timing, etc. of the cycle. This can, for example, bring up a calendar on the screen/display, or bring up a day and/or recurrence options and/or time of day selection. The user can make his or her selections, and those recurrence selections can be locked in by the system software. By way of example, one or more embodiments of the invention, in implementing an automatic recurring self-wash/clean cycle, can include three selection screens: a main cycle selection screen, an options screen for that cycle, and a screen for setting up the specific details of the chosen option.

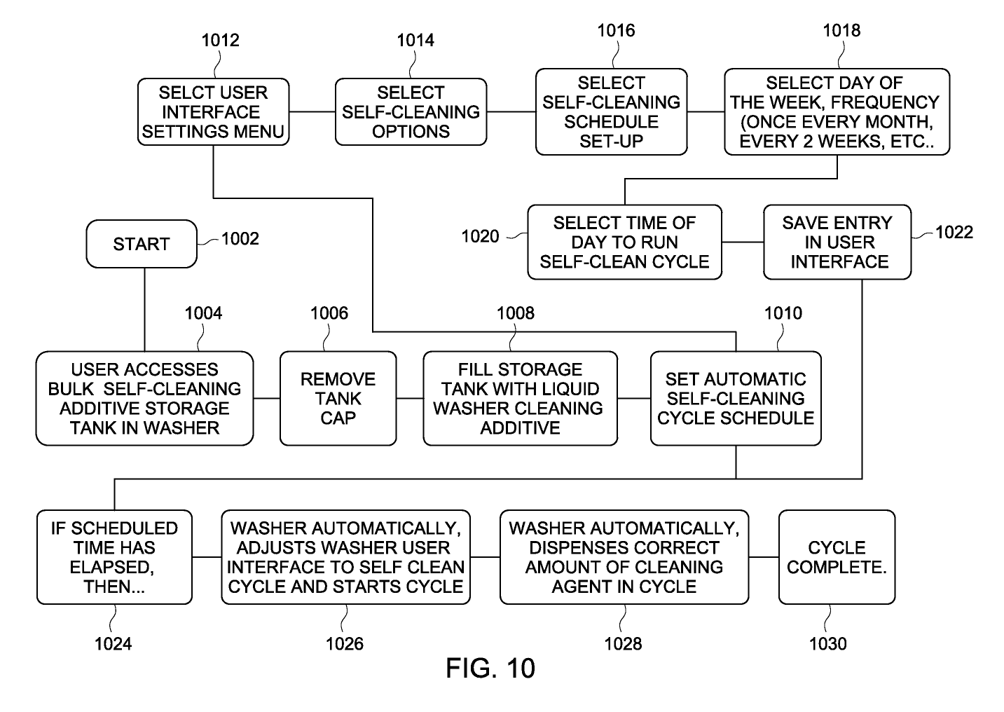

FIG. 10 presents self cleaning washing machine self cleaning flow chart, in accordance with a non-limiting example embodiment of the invention. Step 1002 includes starting the process. Step 1004 includes accessing a bulk self-cleaning additive storage tank in the washer. Step 1006 includes removing the tank cap. Step 1008 includes filling the storage tank with liquid washer cleaning additive. Step 1010 includes setting an automatic self-cleaning cycle schedule. Step 1012 includes selecting a user interface settings menu. Step 1014 includes selecting self-cleaning options. Step 1016 includes selecting self-cleaning schedule set-up. Step 1018 includes selecting day of the week and frequency of cycle (for example, once every month, once every two weeks, etc.). Step 1020 includes selecting the time of day to run the self-clean cycle. Step 1022 includes saving the entry in the user interface.

Also, FIG. 10 includes additional steps as follows. Step 1024 includes determining if the scheduled time has elapsed. If yes, then step 1026 includes the washer automatically adjusting the washer user interface to self-clean cycle and beginning the cycle. Step 1028 includes the washer automatically dispensing the correct amount of cleaning agent (for example, bleach) into the cycle. Step 1030 includes completing the cycle. In one or more embodiments of the invention, also, a user can manually input the cleaning agent (for example, bleach) into a dispenser on a per use basis.

One advantage that may be realized in the practice of some embodiments of the described systems and techniques is the ability to store more than one cycle's worth of a washer additive in the system. Another advantage that may be realized in the practice of some embodiments of the described systems and techniques is enabling a user to automatically set up a calendar with which at some frequency, determined by the user, the machine with automatically clean itself. Yet another advantage that may be realized in the practice of one or more embodiments of the invention include cost savings for consumers in the ability to use bleach as a more accessible, lower cost alternative to costly existing odor eliminating products.

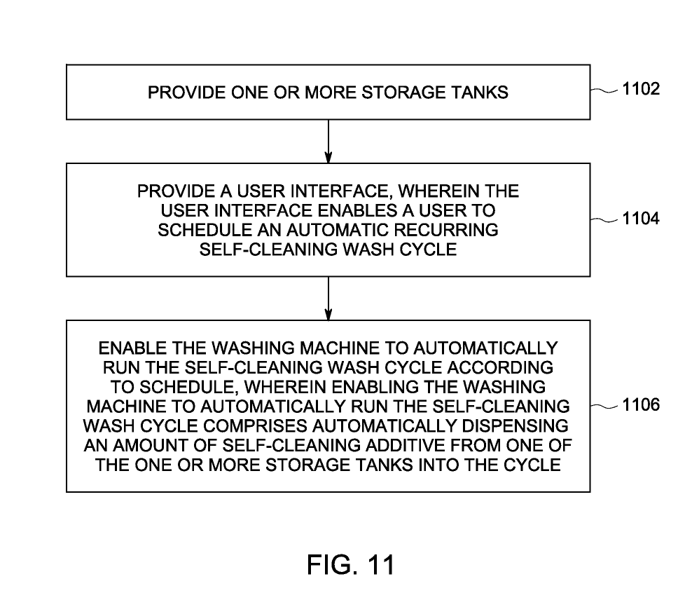

Reference should now be had to the flow chart of FIG. 11. FIG. 11 is a flow chart of a method for automatically running a recurring self-cleaning wash cycle, in accordance with a non-limiting example embodiment of the invention. Step 1102 includes providing one or more storage tanks. Step 1104 includes providing a user interface, wherein the user interface enables a user to schedule an automatic recurring self-cleaning wash cycle. Enabling a user to schedule an automatic recurring self-cleaning wash cycle can include enabling a user to select a day of the week, frequency of cycle (for example, once every month, once every two weeks, etc.), as well as a time of day to run the self-cleaning wash cycle.

Step 1106 includes enabling the washing machine to automatically run the self-cleaning wash cycle according to schedule, wherein enabling the washing machine to automatically run the self-cleaning wash cycle comprises automatically dispensing an amount of self-cleaning additive (for example, bleach) from one of the one or more storage tanks into the cycle. In one or more embodiments of the invention, the amount of self-cleaning additive dispensed from one of the one or more storage tanks into the cycle can be based on one or more characteristics of the cycle (for example, dirtiness of the wash chamber, etc.).

Also, enabling the washing machine to automatically run the self-cleaning wash cycle according to schedule can include, at a scheduled time, automatically adjusting the user interface to self-cleaning wash cycle and beginning the cycle. One or more embodiments of the invention can include saving an automatic recurring self-cleaning wash cycle schedule entry in the user interface.

The techniques depicted in FIG. 11 can also include enabling one or more separate wash cycles to be scheduled and run after a recurring self-cleaning wash cycle has been scheduled into the washing machine. Additionally, one or more embodiments of the invention include facilitating a user to manually input self-cleaning additive into one of the one or more storage tanks on a per use basis.

Furthermore, given the discussion thus far, it will be appreciated that, in general terms, an example apparatus, according to still another aspect of the invention, includes a clothes basket 112 rotatable about an axis 28; a motor 108 coupled to the clothes basket; one or more storage tanks (e.g., tanks 806, 808, 810 or alternative); one or more conveyance mechanisms (e.g., 812, 814, 816, 818) between the each of the one or more storage tanks and a washing chamber; a user interface (e.g., 902 or alternative); a sensor 114; and a processor (e.g., microprocessor 116 or alternative) coupled to the motor, the one or more conveyance mechanisms, the user interface and the sensor. The processor is operative to control the motor, conveyance mechanism(s) and user interface to implement one or more techniques as described herein. The axis 28 can have any orientation; in some cases, such as FIGS. 2 and 3, it may be vertical; in other cases, such as FIGS. 4 and 5, it may be horizontal.

In one or more embodiments of the invention, the user interface can include a touch-screen, and/or a combination of one or more knobs, one or more buttons and a display. Additionally, one or more embodiments of the invention can include a liquid level sensor incorporated in the one or more storage tanks, wherein the status of the liquid level sensor is displayed on the user interface.

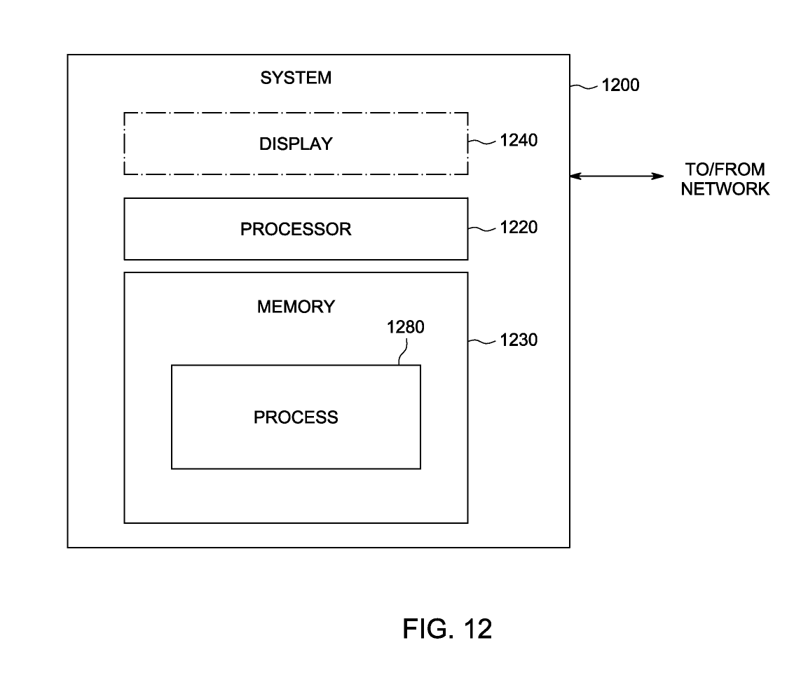

Aspects of the invention (for example, microprocessor 116 or other computer system to carry out design methodologies) can employ hardware and/or hardware and software aspects. Software includes but is not limited to firmware, resident software, microcode, etc. FIG. 12 is a block diagram of a system 1200 that can implement part or all of one or more aspects or processes of the invention. As shown in FIG. 12, memory 1230 configures the processor 1220 to implement one or more aspects of the methods, steps, and functions disclosed herein (collectively, shown as process 1280 in FIG. 12). Different method steps could theoretically be performed by different processors. The memory 1230 could be distributed or local and the processor 1220 could be distributed or singular. The memory 1230 could be implemented as an electrical, magnetic or optical memory, or any combination of these or other types of storage devices. It should be noted that if distributed processors are employed (for example, in a design process), each distributed processor that makes up processor 1220 generally contains its own addressable memory space. It should also be noted that some or all of computer system 1200 can be incorporated into an application-specific or general-use integrated circuit. For example, one or more method steps could be implemented in hardware in an ASIC rather than using firmware. Display 1240 is representative of a variety of possible input/output devices.

As is known in the art, part or all of one or more aspects of the methods and apparatus discussed herein may be distributed as an article of manufacture that itself comprises a tangible computer readable recordable storage medium having computer readable code means embodied thereon. The computer readable program code means is operable, in conjunction with a computer system or microprocessor, to carry out all or some of the steps to perform the methods or create the apparatuses discussed herein. A computer-usable medium may, in general, be a recordable medium (e.g., floppy disks, hard drives, compact disks, EEPROMs, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer (e.g., processor 116) to read instructions and data, such as magnetic variations on a magnetic media or height variations on the surface of a compact disk. The medium can be distributed on multiple physical devices (or over multiple networks). As used herein, a tangible computer-readable recordable storage medium is intended to encompass a recordable medium, examples of which are set forth above, but is not intended to encompass a transmission medium or disembodied signal. Processor 116 may include and/or be coupled to a suitable memory.

The computer system can contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Accordingly, it will be appreciated that one or more embodiments of the present invention can include a computer program comprising computer program code means adapted to perform one or all of the steps of any methods or claims set forth herein when such program is run on a computer, and that such program may be embodied on a computer readable medium. Further, one or more embodiments of the present invention can include a computer comprising code adapted to cause the computer to carry out one or more steps of methods or claims set forth herein, together with one or more apparatus elements or features as depicted and described herein.

It will be understood that processors or computers employed in some aspects may or may not include a display, keyboard, or other input/output components.

Thus, while there have shown and described and pointed out fundamental novel features of the invention as applied to example embodiments thereof, it will be understood that various omissions and substitutions and changes in the form and details of the devices illustrated, and in their operation, may be made by those skilled in the art without departing from the spirit of the invention. Moreover, it is expressly intended that all combinations of those elements and/or method steps which perform substantially the same function in substantially the same way to achieve the same results are within the scope of the invention. Furthermore, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method of operating a washing machine comprising one or more storage tanks and a user interface, wherein the user interface enables a user to schedule an automatic recurring self-cleaning wash cycle, the method comprising:
enabling the washing machine to automatically run the self-cleaning wash cycle according to schedule, wherein the enabling step comprises automatically dispensing an amount of self-cleaning additive from one of the one or more storage tanks into the cycle.

2. The method of claim 1, wherein the user interface enables a user to schedule an automatic recurring self-cleaning wash cycle, the enabling step further comprising enabling a user to select a day of the week and frequency of cycle.

3. The method of claim 1, wherein the user interface enables a user to schedule an automatic recurring self-cleaning wash cycle, the enabling step further comprising enabling a user to select a time of day to run the self-cleaning wash cycle.

4. The method of claim 1, wherein the self-cleaning additive comprises bleach.

5. The method of claim 1, wherein the amount of self-cleaning additive dispensed from one of the one or more storage tanks into the cycle is based on one or more characteristics of the cycle.

6. The method of claim 1, wherein enabling the washing machine to automatically run the self-cleaning wash cycle according to schedule comprises, at a scheduled time, automatically adjusting the user interface to self-cleaning wash cycle and beginning the cycle.

7. The method of claim 1, further comprising saving an automatic recurring self-cleaning wash cycle schedule entry in the user interface.

8. The method of claim 1, further comprising enabling one or more separate wash cycles to be scheduled and run after a recurring self-cleaning wash cycle has been scheduled into the washing machine.

9. The method of claim 1, further comprising facilitating a user to manually input self-cleaning additive into one of the one or more storage tanks on a per use basis.

10. An apparatus comprising:
a clothes basket rotatable about an axis;
a motor coupled to the clothes basket;
one or more storage tanks;
one or more conveyance mechanisms between the each of the one or more storage tanks and a washing chamber;
a user interface;
a sensor; and
a processor coupled to the motor, the one or more conveyance mechanisms, the user interface and the sensor, the processor being operative to:
enable a user to schedule an automatic recurring self-cleaning wash cycle via the user interface; and
enable the self-cleaning wash cycle to automatically run according to schedule via automatically dispensing an amount of self-cleaning additive from one of the one or more storage tanks into the cycle.

11. The apparatus of claim 10, wherein the user interface comprises at least one of a touch-screen, and a combination of one or more knobs, one or more buttons and a display.

12. The apparatus of claim 10, wherein in automatically dispensing an amount of self-cleaning additive from one of the one or more storage tanks into the cycle, the processor is further operative to dispense an amount of self-cleaning additive from one of the one or more storage tanks into the cycle based on one or more characteristics of the cycle.

13. The apparatus of claim 10, wherein the processor is further operative to enable one or more separate wash cycles to be scheduled and run after a recurring self-cleaning wash cycle has been scheduled.

14. The apparatus of claim 10, wherein in enabling a user to schedule an automatic recurring self-cleaning wash cycle via the user interface, the processor is further operative to enable a user to select at least one of a day of the week, frequency of cycle, and a time of day to run the self-cleaning wash cycle.

15. The apparatus of claim 10, further comprising a liquid level sensor incorporated in the one or more storage tanks.

16. The apparatus of claim 15, wherein a status of the liquid level sensor is displayed on the user interface.

17. A computer program product comprising a tangible computer readable recordable storage medium including computer useable program code, the computer program product including:
computer useable program code for enabling a user to schedule an automatic recurring self-cleaning wash cycle; and
computer useable program code for enabling the self-cleaning wash cycle to automatically run according to schedule via automatically dispensing an amount of self-cleaning additive from one of the one or more storage tanks into the cycle.

18. The computer program product of claim 17, wherein the computer useable program code for enabling the self-cleaning wash cycle to automatically run according to schedule via automatically dispensing an amount of self-cleaning additive comprises computer useable program code for dispensing an amount of self-cleaning additive from one of the one or more storage tanks into the cycle based on one or more characteristics of the cycle.

19. The computer program product of claim 17, further comprising computer useable program code for enabling one or more separate wash cycles to be scheduled and run after a recurring self-cleaning wash cycle has been scheduled.

20. The computer program product of claim 17, wherein the computer useable program code for enabling a user to schedule an automatic recurring self-cleaning wash cycle comprises computer useable program code for enabling a user to select at least one of a day of the week, frequency of cycle, and a time of day to run the self-cleaning wash cycle.
